(19) United States
(12) Patent Application Publication
(10) Pub. No.: US 2018/0346080 A1
(43) Pub. Date: Dec. 6, 2018

(54) PERSONAL FLOTATION DEVICE

(71) Applicants: Wayne Walters, Jackson, GA (US); Gabriel Lee Doring, St. Cloud, MN (US)

(72) Inventors: Wayne Walters, Jackson, GA (US); Gabriel Lee Doring, St. Cloud, MN (US)

(21) Appl. No.: 15/996,399

(22) Filed: Jun. 1, 2018

Related U.S. Application Data
(63) Continuation of application No. 62/513,536, filed on Jun. 1, 2017.

(51) Int. Cl. B63C 9/125; A41D 13/012

(52) U.S. Cl. CPC B63C 9/1255; A62B 35/0025; A41D 13/0125

(57) ABSTRACT

The present invention is a personal flotation device comprising an inflatable bladder, a harness configured to be worn on the body of the user comprising a body belt and at least two vertical straps on the front of the harness configured to extend upward over the user's shoulders and connect to the back of the harness, the inflatable bladder attached to the front of the harness and slidably attached to the body belt and the at least two vertical straps, an inflation mechanism configured to inflate the inflatable bladder, and the inflatable bladder configured to expand vertically and horizontally across the user's chest when it is inflated.

This application claims the benefit of U.S. Provisional Patent Application No. 62/513,536 filed on Jun. 1, 2017, which is incorporated by reference in its entirety as if set forth herein.

### BACKGROUND OF THE INVENTION

### Field of the Invention

The invention relates to personal flotation devices (PFDs), and particularly to inflatable PFDs.

### Description of Related Art

Existing inflatable PFDs have two (2) common styles. The first is a stole, which uses a bladder that has two (2) vertical lobes that connect behind the neck to form an upside down “U” shape. The second is a belt pack that has the deflated bladder folded up into a pouch worn around the waist.

For the stole design, the bladder may be connected to the wearer by the bottom of the lobes being fixed at the front to a body belt, or fixed to fabric that is connected to the front of a body belt. The top of the bladder is fixed to a back assembly that continues down the back and connects to the back of the body belt. When worn deflated the bladder is folded inside of a protective cover. When inflated by a CO2 canister, the protective cover breaks away allowing the inflated bladder to expand. The inflated bladder is fixed in place around the body with the middle behind the head and the front lobes on the chest.

This shape of the bladder can also be used in a belt pack style that is worn around the waist. The lower lobes of the bladder are fixed to the body belt directly or by webbing. When inflated, the wearer must place the bladder around their neck for it to properly work as a life jacket. Belt pack styles have also been developed with a pillow type bladder. A generally rectangular bladder that is fixed to the body belt at the lower edge and a strap connected to the bladder on both ends. After inflation of the bladder, the strap must be looped around the head and neck to be secured as a PFD. This is called secondary donning

The present invention is a more comfortable design that places the folded, deflated bladder and inflation mechanisms at the center of the torso. This allows for a fit that doesn't encumber the waist, neck, upper chest, shoulders or arms, and allows for easier secondary donning than current belt packs designs.

### BRIEF DESCRIPTION OF THE DRAWINGS

FIG. 1 is a diagram showing the PFD of the present invention with the bladder inflated.

FIG. 2 is a diagram showing the PFD of the present invention with the bladder folded.

FIG. 3 is a diagram showing the PFD of the present invention configured for continuous wear.

FIG. 4 is a diagram showing the PFD of the present invention showing details of the bladder connection.

### SUMMARY OF THE INVENTION

A personal flotation device comprising an inflatable bladder, a harness configured to be worn on the body of the user comprising a body belt and at least two vertical straps on the front of the harness configured to extend upward over the user's shoulders and connect to the back of the harness, the inflatable bladder attached to the front of the harness and slidably attached to the body belt and the at least two vertical straps, an inflation mechanism configured to inflate the inflatable bladder, and the inflatable bladder configured to expand vertically and horizontally across the user's chest when it is inflated.

### DETAILED DESCRIPTION

The following description is presented to enable any person skilled in the art to make and use the invention. For purposes of explanation, specific nomenclature is set forth to provide a thorough understanding of the present invention. Descriptions of specific embodiments or applications are provided only as examples. Various modifications to the embodiments will be readily apparent to those skilled in the art, and general principles defined herein may be applied to other embodiments and applications without departing from the spirit and scope of the invention. Thus, the present invention is not intended to be limited to the embodiments shown, but is to be accorded the widest possible scope consistent with the principles and features disclosed herein. Moreover, in the present disclosure various devices are described and set forth with regard to several embodiments. It is contemplated that features of the disclosed embodiments may be combined in any manner as may be desired for various applications and implementations.

In various exemplary embodiments of the present invention, an inflatable PFD air bladder is connected to a harness worn around the body and over the shoulders. The uninflated bladder is packaged with an inflation mechanism, oral inflation tube, and gas cylinder and attached to the front of the harness at or near the belt. From this position, the bladder expands from the center out. The edges of the bladder are slidably attached to the horizontal and vertical straps of the harness so that the expansion of the bladder is controlled and the buoyancy is kept close to the user's body without the need for secondary donning. The bladder position can then be adjusted by using adjustments on the harness straps, and there is no need for a neck strap on the bladder, which can be a simple square or rectangular pillow type bladder.

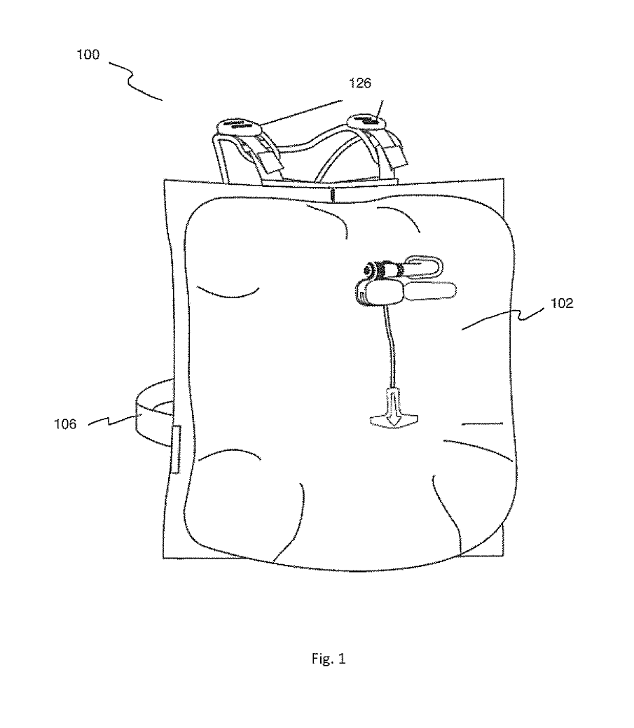

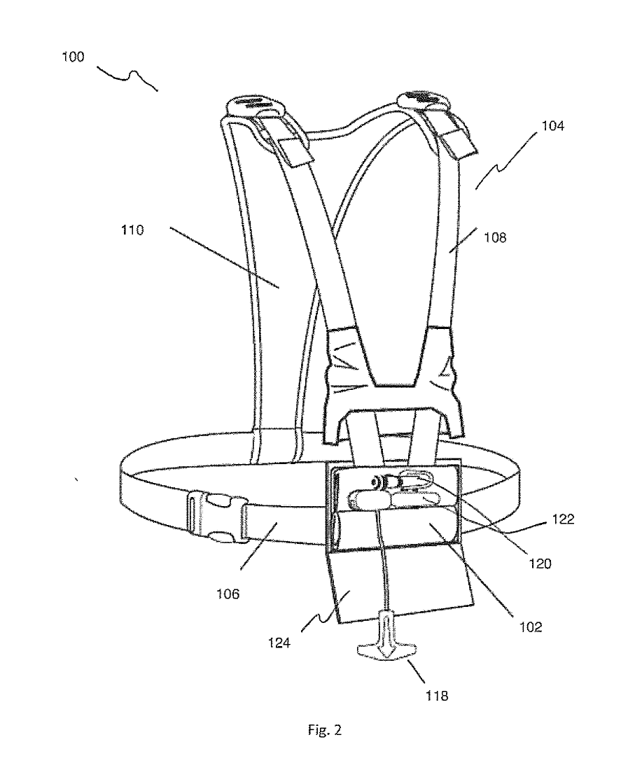

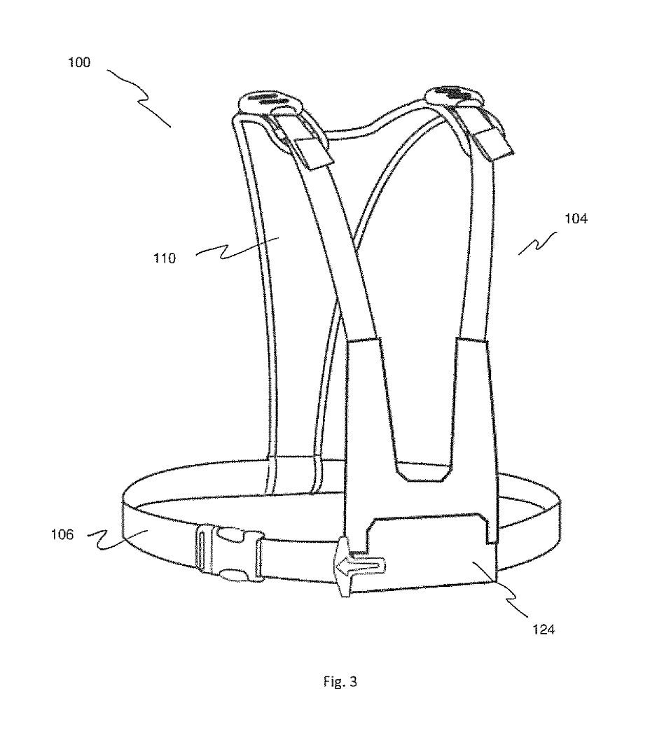

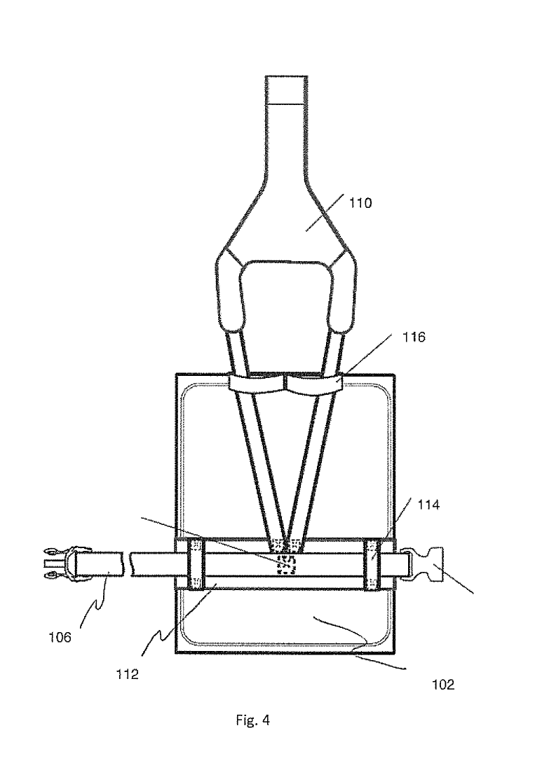

Referring to FIGS. 1 through 4, an exemplary embodiment of the present invention is shown in various states including PFD 100 with the bladder 102 inflated, with the bladder 102 folded, and configured for continuous wear. FIG. 4 shows details of an exemplary connection between the bladder 102 and the PFD harness 104. In various exemplary embodiments, the PFD 100 includes a harness comprised of a body belt 106 that encircles the body horizontally and two vertical straps 108 connected to the body belt 106 at the front middle. As shown in FIGS. 1-4, the vertical straps 108 may connect to a back yoke 110 behind the neck, and the back yoke 110 is connected to the back center of the body belt 106. The body belt 106 may have a buckle or other suitable attachment structure on the front. The buckle or other attachment structure may be offset from center.

In various exemplary embodiments, a generally square or rectangular bladder 102 may be connected to the harness 104 at two points. A horizontal band 112 or strip may be connected to the outside of the bladder 102, just at or below vertical center of the bladder. The center of the horizontal band 112 or strip may be fixed to the body belt 106. In various exemplary embodiments, the horizontal band 112 or strip on the bladder 102 may also have a belt loop 114 on either side with the body belt 106 threaded through such that the belt loops 114 can freely slide along the front of the body belt 106. It will be understood that the strip or band on the bladder could be eliminated and the bladder itself could be fixed to the body belt, with belt loops attached directly to the bladder.

The top edge of the bladder 102 may be connected to the two vertical straps 108 by a loop 116 around each vertical strap 108. The loops 116 may be configured so that they can freely slide up and down the vertical straps 108, allowing the top edge of the bladder 102 to move upward along the vertical straps 108.

During normal wear the deflated bladder 102, inflation mechanism 118, oral tube 120, and CO2 cylinder 122 may be folded and stowed inside a protective cover 124 on the front of the body belt 106 and/or the vertical straps 108. When inflated, the bladder 102 will expand from the center out. The belt loops 114 around the body belt 106 and the vertical straps 108 secure the bladder 102 to the harness and allow it to expand across the wearer's chest and stomach, while keeping the buoyancy of the bladder close the body of the wearer. The wearer does not need to pull a strap over their head, eliminating any secondary donning. If the wearer needs to adjust the buoyancy closer to their body they can tighten the vertical straps 108 with the ladder locs 126 at the shoulders. This pulls the buoyancy closer to the chest.

It will be readily understood that the various exemplary embodiments described above can by rearranged into various different configurations.

What is claimed is:

1. A personal flotation device comprising:
an inflatable bladder;
a harness configured to be worn on the body of the user comprising a body belt and at least two vertical straps on the front of the harness configured to extend upward over the user's shoulders and connect to the back of the harness;
the inflatable bladder attached to the front of the harness and slidably attached to the body belt and the at least two vertical straps;
an inflation mechanism configured to inflate the inflatable bladder; and
the inflatable bladder configured to expand vertically and horizontally across the user's chest when it is inflated.

2. The personal flotation device of claim 1, further comprising a horizontal band connected to the outside of the bladder near the vertical center of the bladder.

3. The personal flotation device of claim 2, wherein the horiztonal band is slidably attached to the body belt.
